(19) United States
(12) Patent Application Publication
(10) Pub. No.: US 2023/0089673 A1
(43) Pub. Date: Mar. 23, 2023

(54) PAINT CONTAINER LID

(71) Applicant: Feyer Finishing Products LLC, Woodbury, MN (US)

(72) Inventors: Matthew Duane Wasche, East Bethel, MN (US); Bradley Thomas Feyereisen, Woodbury, MN (US); Robert Donald Feyereisen, Minneapolis, MN (US)

(21) Appl. No.: 17/448,413

(22) Filed: Sep. 22, 2021

(51) Int. Cl. B44D 3/12; B65D 43/02

(52) U.S. Cl. CPC B44D 3/127; B65D 43/0202; B65D 2543/00092; B65D 2543/00342; B65D 2543/00268

(57) ABSTRACT

A paint container lid has a planar surface and a perforated section embedded in the planar surface. The perforated section can be removed, and a tube or other device or implement can be inserted into a hole created by the removal of the perforated section. The paint container lid further includes a flap positioned on an exterior edge of the planar surface. The flap is used for coupling to a rim of a paint container.

### TECHNICAL FIELD

Embodiments described herein generally relate to container lids, and in an embodiment, but not by way of limitation, paint container lids.

### BACKGROUND

When a person opens a five-gallon pail of paint, the paint or other product in the pail is exposed to many environmental conditions that could possibly contaminate the product. This is especially the case when the five-gallon pail of paint is placed under an airless paint sprayer and left for long periods of time while the sprayer draws paint or other product out of the pail. For example, moisture, wind, debris, and other contaminants can enter the five-gallon pail, thereby decreasing the life of the paint or other product. Additionally, when left for long periods of time, the paint in the pail can dry out.

### BRIEF DESCRIPTION OF THE DRAWINGS

In the drawings, which are not necessarily drawn to scale, like numerals may describe similar components in different views. Like numerals having different letter suffixes may represent different instances of similar components. Some embodiments are illustrated by way of example, and not limitation, in the figures of the accompanying drawings.

FIGS. 1A-1F illustrate a top planar view of a lid for a paint pail or container.

FIG. 2 illustrates a perspective side view of a lid for a paint pail or container.

FIG. 3 illustrates another perspective side view of a lid for a paint pail or container.

FIGS. 4A and 4B illustrate a side view of a lid for a paint pail or container.

### DETAILED DESCRIPTION

The following description and the drawings sufficiently illustrate specific embodiments to enable those skilled in the art to practice them. Other embodiments may incorporate structural, process, and other changes. Portions and features of some embodiments may be included in, or substituted for, those of other embodiments.

An embodiment is a lid for a five-gallon paint pail, container, or bucket. While this embodiment is directed to a five-gallon paint pail, other embodiments are directed to containers of different sizes and containers for other products besides paint. In this embodiment, the lid is made of a cardboard material and is stamped in a shape that is very similar to the top of a standard five-gallon pail. Users can temporarily, but thoroughly, cover and protect the product in the five-gallon pail even while an airless sprayer or other implement is inserted in the pail. The lid prevents moisture, wind, debris, and other contaminants from entering the pail, thus providing a longer and cleaner life of the product while also allowing the sprayer or other implement to function better with less contaminants entering the system. The lid also prevents the paint from drying out. The embodiment is simple to use and easy to install.

The embodiment further includes an integrated tab on each side that grasps the underside of a rim of the pail to hold the lid in place. There is a series of punch-out holes that can be removed by the user to fit a variety of paint sprayers and/or other devices or implements. When the side tabs are utilized to secure the lid to the pail, there are slots for the handle of the pail so the handle can still be utilized. In an embodiment, the lid can be temporarily used and then discarded.

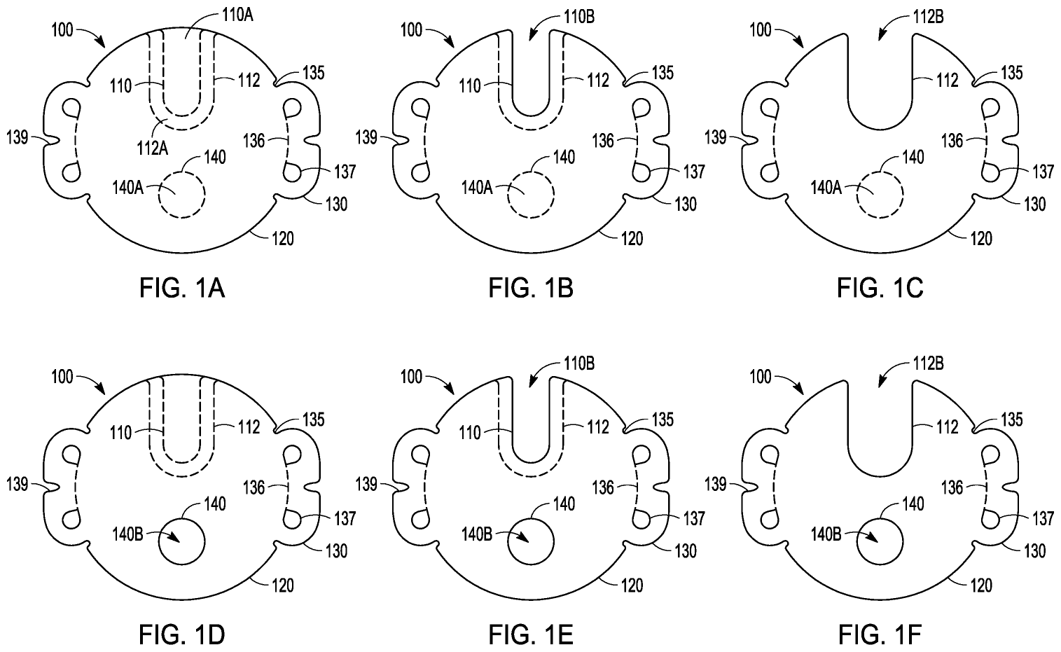

More specifically, referring first to FIG. 1A, a top view of an embodiment of a paint container lid 100 is illustrated. The lid 100 is circular in shape, and specifically is shaped and sized to fit on top of a typical five-gallon paint pail. The lid has perforated lines 110, 112, which define generally oblong-shaped sections. The two perforated lines 110, 112 permit the user to create two different sized oblong openings in the lid. Removal of the lid section 110A that is outlined by perforated line 110 creates the oblong opening 110B as illustrated in FIGS. 1B and 1E, and removal of the lid section 112A that is outlined by perforated line 112 creates the oblong opening 112B as illustrated in FIGS. 1C and 1F. The lid 100 further includes a perforated circular line 140, which forms lid section 140A, and which further forms circular opening 140B when a user removes the section 140A along perforated lines 140 as illustrated in FIGS. 1D, 1E, and 1F.

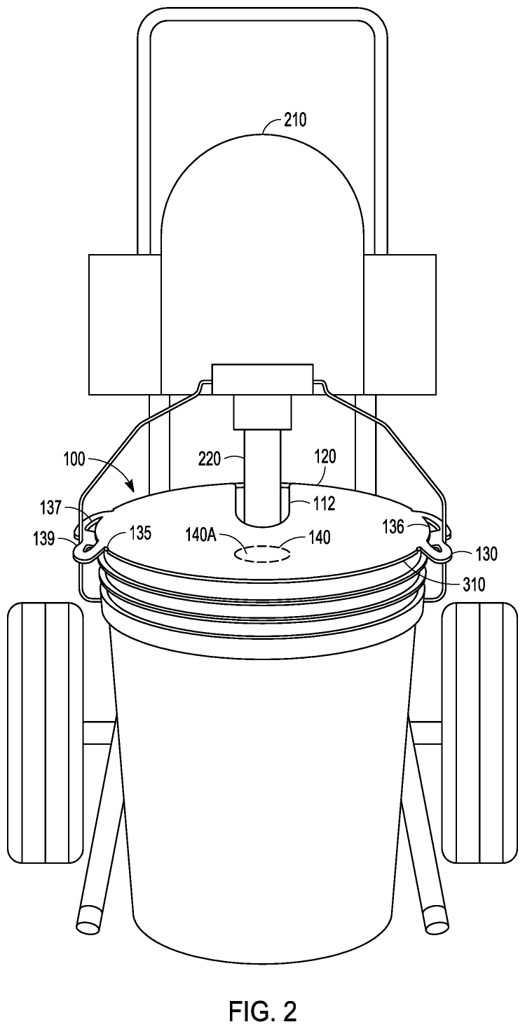

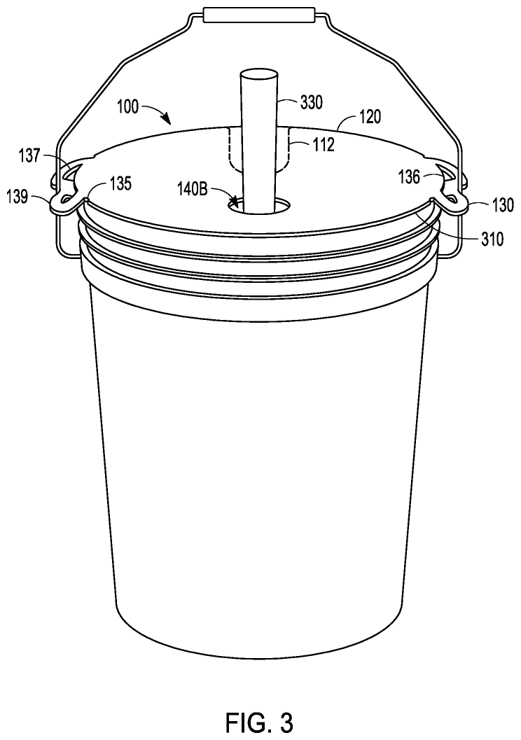

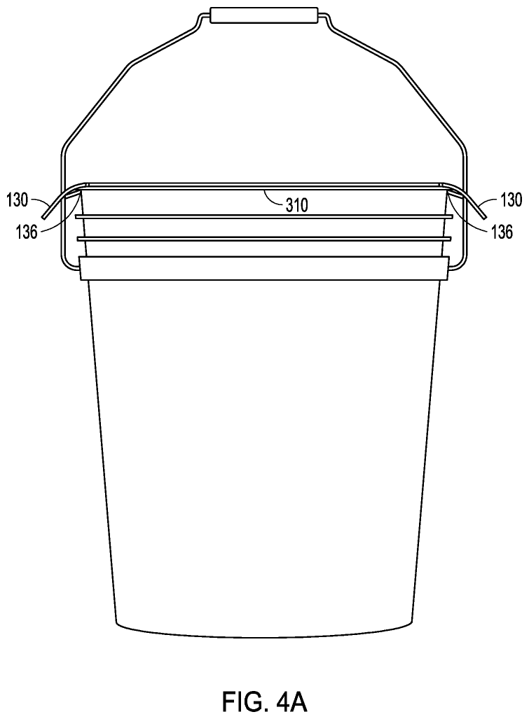

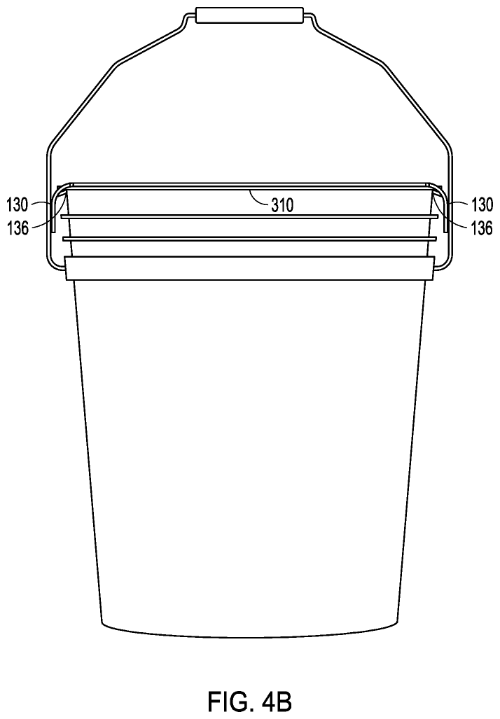

FIG. 1A further illustrates side flanges, tabs, or flaps 130. A function of the flaps 130 is to secure the lid 100 to a pail as will be described herein. An indentation 135 is located between the outer edge 120 of the lid 100 and the flaps 130. This indentation 135 serves as a bending point for the flaps 130. A perforated line 136 further serves as a bending/breaking point for the flaps 130, and the perforated line 136 is shaped in a curved fashion that approximates the arc of a top rim of a five-gallon bucket. The edge formed by the perforated line 136 when the perforated line 136 is broken serves to secure the lid 100 to an underside of a rim 310 of a paint bucket as disclosed herein and as illustrated in FIGS. 4A and 4B. The flaps 130 further include two holes 137 that are positioned at each end of the perforated line 136. These two holes 137 help to relieve stress on the handles of the bucket. Specifically, by having holes 137 in place, there is less binding and stress on the remaining material of the lid, especially when the lid is manufactured from cardboard. Creating less stress on the lid material helps maintain strength in the remaining flaps 130 and still allows the lid material to bend without losing its integrity. Additionally, the holes 137 help the user when they need to adjust the lid 100 to line up with the bucket handle. The holes 137 act as good anchor points for the user's fingers. The flaps 130 also include notches 139, which receive the handle of a bucket and permit the handle to remain upright and easy to grasp as illustrated in FIGS. 2 and 3.

FIGS. 2 and 3 further illustrate the manner in which the lid 100 can be secured to a five-gallon bucket. In FIG. 2, the bucket is first placed under an airless sprayer 210. Depending on the size of the airless sprayer feed/nozzle 220, either oblong opening 110B or oblong opening 112B is created along the perforated lines 110, 112 respectively. The lid 100 is then placed on top of the bucket such that the airless sprayer feed/nozzle 220 enters the bucket through oblong opening 110B or 112B. Downward pressure is applied to the flaps 130 at or near perforated line 136 so that the perforated line 136 is broken, and the flaps 130 are pushed down below the plane of the lid 100. In this embodiment, the flap then engages the underside of a rim 310 at about a 45-degree angle, thereby securing the lid 100 to the top of the bucket. As noted above, the lid 100 prevents adulterants from entering the paint bucket, and also prevents the paint from drying out. After use, the lid 100 can be discarded.

Referring to the embodiment of FIG. 3, perforated circular line 140 is punched out to create circular opening 140B, and the lid 100 is once again placed on top of the bucket. Downward pressure is applied to the flaps 130 at or near perforated line 136 so that the perforated line 136 is broken, and the flaps 130 are pushed down below the plane of the lid 100. The flaps 130 then engage the underside of the rim 310, and the lid 100 is then secured on top of the bucket. A paint roller can be kept in the bucket (for example, when a painter is taking a lunch break), and the paint roller handle 330 can protrude through the opening 140B. When the painter returns, the protective lid 100 can be removed, and the painter can then continue with painting. As noted above, the lid 100 prevents adulterants from entering the paint bucket, and also prevents the paint from drying out. After use, the lid 100 can be discarded.

FIG. 4A illustrates an embodiment wherein the flaps 130 are pushed down to about a 45-degree angle, and the flaps 130 at perforated line 136 lock under the rim 310 of the bucket. FIG. 4B illustrates an embodiment wherein the flaps 130 are pushed down such that the flaps 130 are substantially perpendicular to the base of the bucket, and the flaps 130 at perforated line 136 lock under the rim 310 of the bucket.

The above detailed description includes references to the accompanying drawings, which form a part of the detailed description. The drawings show, by way of illustration, specific embodiments that may be practiced. These embodiments are also referred to herein as “examples.” Such examples may include elements in addition to those shown or described. However, also contemplated are examples that include the elements shown or described. Moreover, also contemplated are examples using any combination or permutation of those elements shown or described (or one or more aspects thereof), either with respect to a particular example (or one or more aspects thereof), or with respect to other examples (or one or more aspects thereof) shown or described herein.

Publications, patents, and patent documents referred to in this document are incorporated by reference herein in their entirety, as though individually incorporated by reference. In the event of inconsistent usages between this document and those documents so incorporated by reference, the usage in the incorporated reference(s) are supplementary to that of this document; for irreconcilable inconsistencies, the usage in this document controls.

In this document, the terms “a” or “an” are used, as is common in patent documents, to include one or more than one, independent of any other instances or usages of “at least one” or “one or more.” In this document, the term “or” is used to refer to a nonexclusive or, such that “A or B” includes “A but not B,” “B but not A,” and “A and B,” unless otherwise indicated. In the appended claims, the terms “including” and “in which” are used as the plain-English equivalents of the respective terms “comprising” and “wherein.” Also, in the following claims, the terms “including” and “comprising” are open-ended, that is, a system, device, article, or process that includes elements in addition to those listed after such a term in a claim are still deemed to fall within the scope of that claim. Moreover, in the following claims, the terms “first,” “second,” and “third,” etc. are used merely as labels, and are not intended to suggest a numerical order for their objects.

The above description is intended to be illustrative, and not restrictive. For example, the above-described examples (or one or more aspects thereof) may be used in combination with others. Other embodiments may be used, such as by one of ordinary skill in the art upon reviewing the above description. The Abstract is to allow the reader to quickly ascertain the nature of the technical disclosure. It is submitted with the understanding that it will not be used to interpret or limit the scope or meaning of the claims. Also, in the above Detailed Description, various features may be grouped together to streamline the disclosure. However, the claims may not set forth every feature disclosed herein as embodiments may feature a subset of said features. Further, embodiments may include fewer features than those disclosed in a particular example. Thus, the following claims are hereby incorporated into the Detailed Description, with a claim standing on its own as a separate embodiment. The scope of the embodiments disclosed herein is to be determined with reference to the appended claims, along with the full scope of equivalents to which such claims are entitled.

1. A paint container lid comprising:
a circular planar surface;
a perforated section embedded in the circular planar surface, the perforated section operable for removal and receipt of a paint sprayer feed nozzle or a paint roller handle; and
a flap positioned on an exterior edge of the circular planar surface, the flap operable for coupling to a rim of a paint container;
wherein the flap shares an arced, perforated section with the circular planar surface that is operable for binding with the rim of the paint container.

2. (canceled)

3. The paint container lid of claim 1, wherein the planar surface comprises cardboard.

4. The paint container lid of claim 1, wherein the perforated section comprises multiple integrated perforated sections.

5. The paint container lid of claim 1, wherein the circular planar surface comprises multiple separate perforated sections.

6. The paint container lid of claim 1, wherein the perforated section is circular.

7. The paint container lid of claim 1, wherein the perforated section is oblong.

8. The paint container lid of claim 1, wherein the paint container comprises a five-gallon paint container.

9. The paint container lid of claim 1, comprising an indentation positioned between the exterior edge and the flap, the indentation serving as a bending point for the flap.

10. (canceled)

11. The paint container lid of claim 1, comprising an opening on each end of the arced, perforated section, the opening operable for relieving stress on a handle of the paint container.

12. The paint container lid of claim 1, wherein the flap comprises a notch for receiving a handle of the paint container.

13. A paint container lid for a five-gallon paint container comprising:
a circular, planar surface;
an oblong, perforated section embedded in the circular, planar surface, the oblong, perforated section operable for removal and receipt of a tube or device;
a circular, perforated section embedded in the circular, planar surface, the circular, perforated section operable for removal and receipt of the tube or the device;
a flap positioned on an exterior edge of the circular, planar surface, wherein the flap comprises an arced, perforated section operable for binding with a rim of the paint container, and wherein the flap comprises a notch for receiving a handle of the paint container;
an opening on each end of the arced, perforated section, the opening operable for relieving stress on a handle of the paint container; and
an indentation positioned between the exterior edge and the flap, the indentation serving as a bending point for the flap.

14. The paint container lid of claim 13, wherein the planar surface comprises cardboard.

15. The paint container lid of claim 13, wherein the perforated section comprises multiple integrated perforated sections.

16. The paint container lid of claim 13, wherein the planar surface comprises multiple separate perforated sections.

17. A container lid comprising:
a circular planar surface;
a perforated section embedded in the circular planar surface, the perforated section operable for removal and receipt of a paint sprayer feed nozzle or a paint roller handle; and
a flap positioned on an exterior edge of the circular planar surface, the flap operable for coupling to a rim of a five gallon paint pail;
wherein the flap comprises an arced, perforated section operable for binding with the rim of the five gallon paint container.

18. (canceled)

19. (canceled)

20. The container lid of claim 17, wherein the container lid comprises cardboard.

21. The paint container lid of claim 10, wherein the arced, perforated section operable for binding with the rim of the paint container is operable for detachment at the perforated section toward a bottom of the paint container and contacting a bottom side of the rim.
